(19) United States
(12) Patent Application Publication
(10) Pub. No.: US 2013/0024277 A1
(43) Pub. Date: Jan. 24, 2013

(54) PLATFORM TO PROVIDE ADVERTISEMENTS TO USERS OF REGISTERED PRODUCTS

(71) Applicants: Kenneth D. Tuchman, Englewood, CO (US); Bruce A. Sharpe, Aurora, CO (US); Henry D. Truong, Chelmsford, MA (US)

(72) Inventors: Kenneth D. Tuchman, Englewood, CO (US); Bruce A. Sharpe, Aurora, CO (US); Henry D. Truong, Chelmsford, MA (US)

(73) Assignee: TELETECH HOLDINGS, INC., Englewood, CO (US)

(21) Appl. No.: 13/185,309

(22) Filed: Jul. 18, 2011

(51) Int. Cl. G06Q 30/00

(52) U.S. Cl. 705/14.49; 705/304

(57) ABSTRACT

A service center identifies a first and a second users supported by the service center for products registered with the service center, where the service center is configured to provide support services to the users concerning the products on behalf of vendors that provide the products, wherein the first user and the second user have at least one common product registered with the service center. The service center determines whether the first user and the second user are members of a social community that is communicatively coupled to the service center via a first an application programming interface (API), where the social community is hosted by a third party over a network. A message is transmitted to a first mobile device associated with the first user to enable the first user to connect with the second user via the social community without requiring the first user directly accessing the social community.

### FIELD OF THE INVENTION

Embodiments of the present invention relate generally to providing product services. More particularly, embodiments of the invention relate to providing advertisements to users of registered products.

### BACKGROUND

Prior to the advent and prolific use of distributed network environments such as the Internet, customer service sessions typically occurred over a teleconference between a customer service agent or service specialist and a customer. These teleconferences, which incidentally are still very popular today, are initiated by a customer placing a phone call to a customer service agent. The customer service agent's phone receives the call through a public-switched telephone network (PTSN). Many support centers handle a large volume of inquiries, usually by phone, for sales, information, customer support and other services. Typical support centers provide the ability to route multiple incoming, customer-initiated calls to agents which provide sales, information, or support on behalf of an entity interested in establishing or maintaining a relationship with the customer.

Modern support center systems selectively route incoming calls based on a number of factors such as the number called or dialed, the originating number, the queued sequence of the caller, the geographic location of the caller, accumulated caller history, and other relevant criteria. Once the system has evaluated the inbound caller's information, if any, the system searches for an available agent to service the call. Availability of agents may be dependent on any number of factors such as a skill level or a schedule of the agent. The number of agents within the contact center and available to the system may often be limited by the physical space available for the agents to operate. Contact centers have to deal with a limited number of agents to handle a large number of incoming customer calls.

As the Internet is getting more popular, customer service providers now provide for computer-based customer service interaction by way of the World Wide Web. Instead of initiating a customer service session by using the phone, customers may access a website and engage in a web-based customer service session to make inquiries (e.g., technical support) and/or perform tasks (e.g., paying bills). Web-based customer service sessions offer numerous advantages over teleconference-based sessions. For example, the graphical user interface of web-based customer service applications permit customers to view illustrations or written explanations and thus ameliorate the miscommunications which may arise with oral conversations between a customer service agent and a customer.

Further, web-based customer service sessions enable a customer to directly target his/her needs on the website and thus reduce the time expended both in navigating through a series of vocal menu choices inapplicable to the consumer's particular needs and in waiting to speak to a service agent. Significantly, web-based customer service sessions are particularly cost-effective for the customer service provider given that fewer agents are required to communicate with customers. Indeed, customers are provided functionality for finding answers to their questions or performing tasks without any help from a live agent. These customer service sessions may be entirely computer-based or, alternatively, involve interaction with a customer service agent.

While there are advantages to performing customer service sessions over the web or other distributed network environments, there has been a lack of efficient platforms to take full advantage of today's technologies, particularly, the mobile technologies. In order to obtain customer support from a service center, the customer is still required to take many steps of manual processes such as a complicated process for registering a product. While there are many ways (e.g., email, chat, voice) to communicate between a customer and an agent, there has been a lack of an efficient mechanism to provide the customer the best available and cost effective communication channels to an agent.

In addition, a typical support center only provides support services to the customers; it does not provide any other services for the customers' products. In particular, a conventional support center does not provide advertisement services for vendors of products associated with the users in an efficient way. A conventional support center also does not provide a mechanism to connect users having common products and/or social community memberships to connect with each other.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating a system for providing life cycle services to products according to one embodiment of the invention.

FIG. 2 is a block diagram illustrating an example of a service center according to another embodiment of the invention.

FIG. 3 is a flow diagram illustrating a method for providing life cycle services of a product according to one embodiment of the invention.

FIG. 4 is a flow diagram illustrating a method for configuring message delivery according to one embodiment of the invention.

FIG. 5 is a block diagram illustrating an advertisement system according to one embodiment of the invention.

FIG. 6 is a flow diagram illustrating a method of providing advertisements according to another embodiment of the invention.

FIGS. 7A-7L are screenshots illustrating examples of graphical user interfaces according to some embodiments of the invention.

FIG. 8 is a block diagram illustrating a service center having a social community accessing platform according to one embodiment of the invention.

FIG. 9 is a flow diagram illustrating a method for social posting via a service center according to one embodiment of the invention.

FIG. 10 is a flow diagram illustrating a method for providing social community services according to one embodiment of the invention.

FIGS. 11A-11B are screenshots illustrating an example of a graphical user interface according to one embodiment of the invention.

FIGS. 12A-12C are screenshots illustrating graphical user interfaces for posting items on social communities according to one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some aspects, a service center provides a single platform to provide not only support services to a product or loyalty program registered by a user, but also other services such as selling or disposal of the product, participation in a discussion forum associated with the product, and providing advertisements, promotions, rewards, and/or recall associated with the product on behalf of a vendor of products such as a client or manufacturer. These services can be provided to or initiated from a user through an application running within a mobile device through a variety of communications channels, without having to leave the same application from the mobile device and without requiring the user to provide detailed information about the product.

According to one aspect, in addition to registering a product with the service center, a user can also register, for example, through the application running within a mobile device, one or more social communities, one or more payment processing providers, and/or one or more eCommerce sites by storing the necessary credentials (e.g., usernames and passwords) of the servers hosting the social communities, the payment processing sites, and eCommerce sites in a database (e.g., user database) of the service center, where the database is associated with a user of the mobile device (but not limited to the mobile device). Subsequently, the user can transmit from the mobile device a sales request to sell or dispose a registered product by specifying one or more of the eCommerce sites. Similarly, a user can also post a message or item to one or more of the registered social communities from the application running within the mobile device without having to individually access the social communities.

In another aspect, a user can also configure a set of one or more rules to specify whether certain types of messages or advertisements received from vendors or parties (e.g., retailers, manufacturers, social communities, or other advertisement providers), which may or may not be related to a registered product, should be routed to the user. These rules serve as part of message delivery or filtering rules. The service center engages with the related parties to allow the related parties to get in touch with the user by sending certain messages such as product promotions, rewards, and/or recalls, etc. to the user. The service center may send a message to a user via one or more communications channels preferred by the user, which may also be configured as a set of rules and stored in a database associated with the user.

According to another aspect, an advertisement received from a vendor is delivered by the service center to a mobile device of a user based on a set of delivery rules associated with the user. The advertisement is displayed on a display of the mobile device by an application running therein. In addition, the service center and/or the application are configured to track interactions of the user with respect to the displayed advertisement to determine user behaviors, patterns, or trends in view of the displayed advertisement. An analysis is performed on the user interaction and the result of the analysis may be utilized to configure further advertisement delivery by the service center and/or the vendors.

According to another aspect, a service center is configured to identify users that have at least one common product registered with the service center and are also members of a social community. The service center is configured to send a message to those users to invite them to connect (e.g., becoming friends or following a friend) with each other via the social community. The social community is hosted by a third party and communicatively coupled to the service center over a network. The service center may also deliver messages or items posted by one of those users to another one of those users on behalf of the social community, without requiring such users to individually or directly accessing the social community. The service center can also deliver messages or items to a particular user posted by other users of the social community, where the messages or items are related to a registered product of that particular user.

According to a further aspect, an application running on a mobile device provides a user friendly graphical user interface (GUI) to allow a user to configure a set of one or more delivery rules concerning whether certain types of messages or advertisements should be received at the mobile device from a service center. The service center is configured to deliver messages or advertisements on behalf of a message or advertisement provider, which can be a client to the service center, a retailer, a manufacturer, a social community, or other content providers. A user can utilize the GUI to configure, for each of the providers, whether a message associated with a particular registered product of the user or all products in general related to the provider should be received by the mobile device. The settings of the delivery rules are then transmitted from the mobile device to the service center to allow the service center to delivery subsequent messages or advertisements on behalf of the message or advertisement providers accordingly.

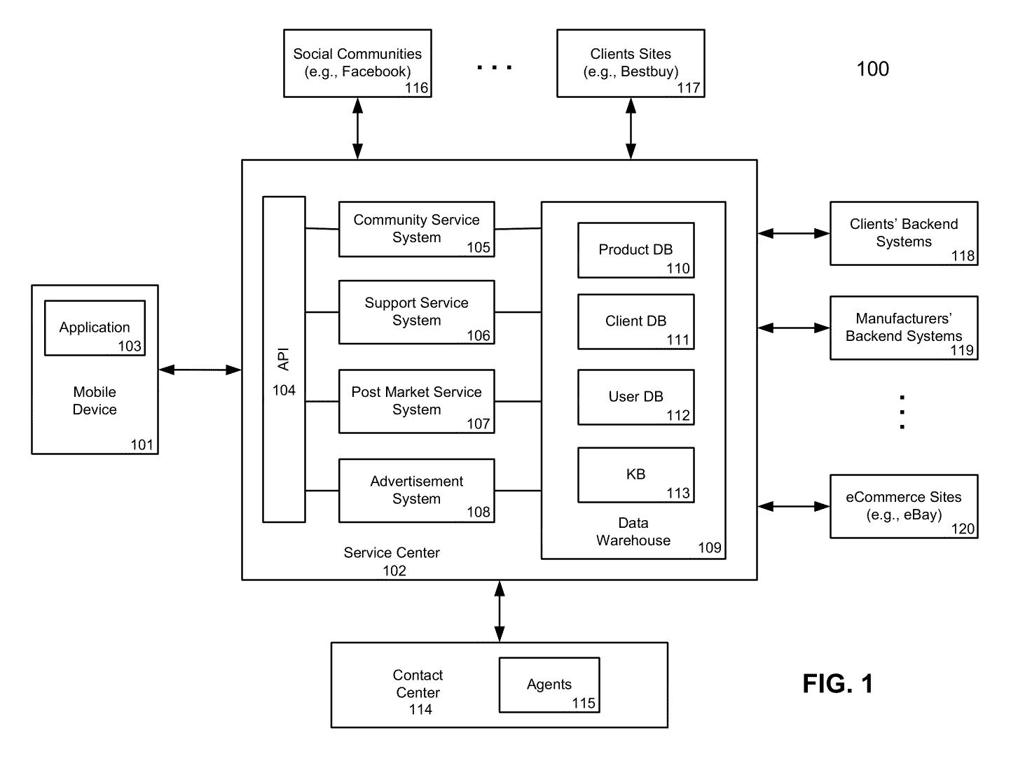

FIG. 1 is a block diagram illustrating a system for providing life cycle services to products according to one embodiment of the invention. Referring to FIG. 1, system 100 includes a mobile device 101 of a user, customer, or individual communicatively coupled to service center 102 over a network. The network may be any kind of networks. Mobile device 101 may be any kind of mobile devices including, but is not limited to, a laptop, mobile phone, tablet, media player, personal digital assistant or PDA, etc.

Service center 102 may be implemented in a centralized facility or server. Alternatively, service center 102 may be implemented in multiple facilities or servers in a distributed manner (e.g., cloud-based service platforms). Service center 102 provides services to a variety of products or services from a variety of clients or vendors. A client may be a manufacturer, a distributor, a retailer, a service provider or broker, a purchasing facility (e.g., Amazon™, Expedia™, or ISIS™), or a combination thereof. In one embodiment, service center 102 includes service APIs 104 to communicate with other systems such as mobile device 101, client's site 117, social communities 116, contact center 114 including agents or experts 115, client backend systems 118, manufacturer backend systems 119, eCommerce sites 120 and other auxiliary systems (e.g., billing system). Service center 102 can handle service requests from customers of multiple clients. For example, a service center may handle customer service requests for a number of retail sales companies, sales calls for catalog sales companies, and patient follow-up contacts for health care providers. In such a structure, the service center may receive service requests directly from the customers or through client support management systems.

In one embodiment, service center 102 further includes community service system 105, support services system 106, post market service system 107, messaging system 108, and data warehouse 109. Support services system 106 is responsible for handling support services requests from the users, including identifying and registering a product, creating an instance case context, selecting and assigning a customer representative (also referred to herein as an agent, specialist, or expert) to provide support services to the users, and managing work flows, etc. An agent may be selected based on a skill set or expertise of the agent, as well as other factors such as geographic location, of the agent. The term “agent,” “specialist,” or “expert” refers to a service center personnel or a computerized application, in some cases, that respond to customer requests. An agent may be locally situated at the service center or remotely situated over a network. Throughout this application, the terms of “agent,” “specialist,” and “expert” are interchangeable terms dependent upon the circumstances. In most cases, the term of “agent” collectively refers to a customer representative, a support agent, a support specialist, a support expert, or a combination thereof, which may be a service center personnel and/or a computerized application.

In one embodiment, community service system 105 is responsible for communicating with social communities 116 via an API, for example, to post a message received from a user and to route the responses received from social communities 116 back to the user. Post market service system 107 is responsible for handling post market activities associated with the registered products, including selling a registered product on eCommerce sites 120 and arranging a disposal facility to dispose or recycle the product, etc. Messaging or advertisement system 108 is responsible for handling any messages received from a variety of partners or parties, such as client sites 117, client backend systems 118, manufacturer backend systems 119, and eCommerce sites 120. Messages may be related to the registered products of the user, such as, promotions, rewards, and recall messages. Messages may include advertisements from a variety of advertisement providers.

In one embodiment, data warehouse 109 includes product database 110, client database 111, user database 112, and knowledgebase 113. Product database 110 is configured to store any data related to the registered products including user manuals, etc. Client database 110 is configured to store information related to clients such as client's preferred communications mechanisms. User database 112 is used to store information related users, such as, for example, registered products associated with a user, communications channel preference of a user, credentials necessary for a user to access other sites, and/or messaging filtering settings of a user, etc. Knowledgebase 113 is used to store knowledge collected and compiled over a period of time, which can be used by agents 115 and/or users for self-support purposes.

In one embodiment, service center 102 further includes a multi-channel communication system (not shown) to provide one or more communication channels to any user or client to concurrently access service center 102. Examples of communication channels include email, chat, texting (e.g., short messaging services or SMS), voice (e.g., automated IVR, real-time, or VoIP), video, Web (e.g., Web conferencing), and/or online community forum (e.g., Facebook™ or Twitter™), etc. Note that the multi-channel communication system may be fully or partially integrated with service center 102 or alternatively, it may be maintained or provided by a third party or partner (e.g., communicatively coupled via service API 104 over a network). Service center 102 further includes an automatic caller distribution (ACD) system (not shown) to receive, route, and manage voice calls exchanged via the multi-channel communication system.

A customer can obtain support services from service center 102 via a variety of communication mechanisms. A customer can initiate a support request to contact a live agent such as agents 115 in a live manner. Alternatively, a customer may browse certain knowledgebase, such as KB 113 via a Web interface, in an attempt to find a solution to a problem of a product he/she purchased from a manufacturer via a client of service center 102.

According to one embodiment, application 103 is installed on mobile device 101 of a customer or user, where application 103 can serve as a central service point to service center 102 that provides support services to a variety of products or services provided by a variety of vendors. The vendors can be, for example, manufacturers, distributors, retailers, service brokers, purchasing houses, etc. of the products. Vendors may be the clients of service center 102 or entities having a business relationship with service center 102. A user (also referred to herein as a customer) can activate application 103 from the user's mobile device 101 to reach agents 105 the service center 102 or KB data center 114 via a variety of communication channels or media, such as, for example, email, chat, voice (including automated interactive voice recognition or IVR, voice over Internet protocol or VoIP), video, Web, and/or online community-based forum, etc. Application 103 can be a thin/thick client application or a Web-based application.

Note that a service center described throughout this application is not limited to a traditional service center or support center, nor is it implemented in a single physical location. A service center described herein represents a collection of service logic or providers communicatively coupled to each other over a network in a distributed or a cloud-based fashion. The term of a service center herein represents any kind of service providers that provide a variety of services to customers or users. As described throughout this application, a service center can be a set of enabling cloud-based service APIs, which enable a variety of consumer product services and support offerings via an intelligent set of technologies providing automated and/or live communications. In one embodiment, services provided by a service center can include, but not limited to: 1) user, product, and loyalty registration and support services; 2) product wish list, reviews, and comparisons; 3) purchasing and accessorizing services; 4) social community support and integration services; 5) intelligent knowledge support services; and 6) integrated sales and product disposition services, etc.

Also note that an agent, an expert, or a customer representative described throughout this application is not limited to a real person. The term of an agent, an expert, or a customer representative can also refer to any processing logic or functional block that is configured or programmed to provide automated services to a customer, for example, via services APIs of the service center, without a need of a real person involved. Such processing logic and/or functional blocks can be implemented in software, hardware, or a combination thereof. Further detailed information concerning service center 102 can be found in co-pending U.S. patent application Ser. No. 13/085,397, filed Apr. 12, 2011, which is incorporated by reference in its entirety.

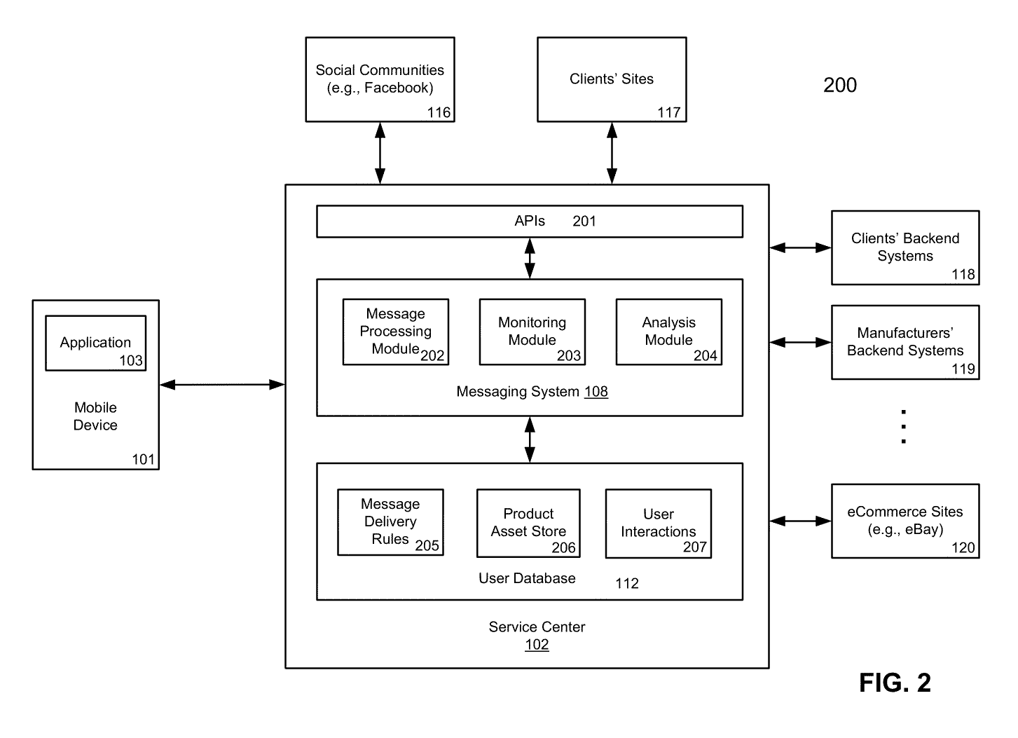

FIG. 2 is a block diagram illustrating a system for processing messages within a service center according to one embodiment of the invention. System 200 may be implemented as part of system 100 of FIG. 1. Referring to FIG. 2, service center 102 includes messaging system 108 to receive messages, via one or more APIs 201, from a variety of sources, such as social communities 116, client sites 117, client backend systems 118, manufacturer backend systems 119, and eCommerce sites 120. The messages may or may not be related to the registered products stored in asset store 206 of user database 112 associated with the registered users. For example, a message may be an advertisement received from a retailer or manufacturer, including, but is not limited to, a promotion of a related product or accessory to a registered product, a discount coupon, an upgrade, or a service schedule reminder, etc. Alternatively, a message may be a recall notification concerning a registered product of a user.

In one embodiment, a user can configure a set of one or more delivery rules 205 specifying whether a particular type of messages or advertisements should be routed to the user. Delivery rules 205 may also specify whether a message or a particular type of messages associated with a particular registered product should be received by the user. Delivery rules 205 can also specify whether a message received from a particular source should be forwarded to the user. In one embodiment, certain types of messages are not available to be filtered out. For example, any recall message of any registered product must be routed to users, regardless of the configuration of delivery rules 205. A message may be routed to a user using one or more communications channels configured by the user as communications preference, which may also be stored in user database 112.

A message may include an advertisement of products and/or services for a consumer or user delivered via a traditional advertisement service such as Google®, etc. A message may include an offer to a customer provided directly from a manufacturer, loyalty provider, etc., where an offer may be all offers for a product line or only for products registered, or a wish list via the service center. A message may include a social feed received from a variety of social communities. A social feed may be related to user community feedback, comments, suggestions or experience of a particular product or service discussed by their community members or friends.

In one embodiment, in response to a message received one of sources 116-120, message processing module 202 is configured to determine whether the message should be delivered to a user associated with mobile device 101 based on a set of delivery rules 205 associated with the user. If delivery rules 205 permit, the message is routed to mobile device 101 or one of other devices associated with the user dependent upon the settings of the communications channel preference (not shown). As described above, message may be related to a registered product specified in asset store 206 of the user. Alternatively, the message may be related to other products or services that are likely interesting to the user, for example, based on user's interactive history, habits, and/or registered products or services, which may be captured and determined over a period of time by monitoring module 203 and/or analysis module 204 and stored as part of user interactions 207.

According to one embodiment, a user of mobile device 101 can set its preference via application 103 for any messages, advertisements, offers, or feeds that would be presented to mobile device 101. Application 103 provides user friendly GUIs to allow the user to specify the message delivery preferences, including manufacturer offers (e.g., product or service offers from a variety of manufacturers such as Dell®, Samsung®, etc.), loyalty offers (e.g., products or services offers from a variety of loyalty or brand providers such as Best Buy®), social feeds (e.g., feeds based on products from social communities such as Facebook® or Twitter®), and other advertisement providers. For each of the message sources, in one embodiment, a user can turn off message delivery for the particular source, turn on the message delivery only for the products registered by the user (e.g., registered products or wish list), or turn on the message delivery for all products provided by the particular source, regardless whether such products have been registered.

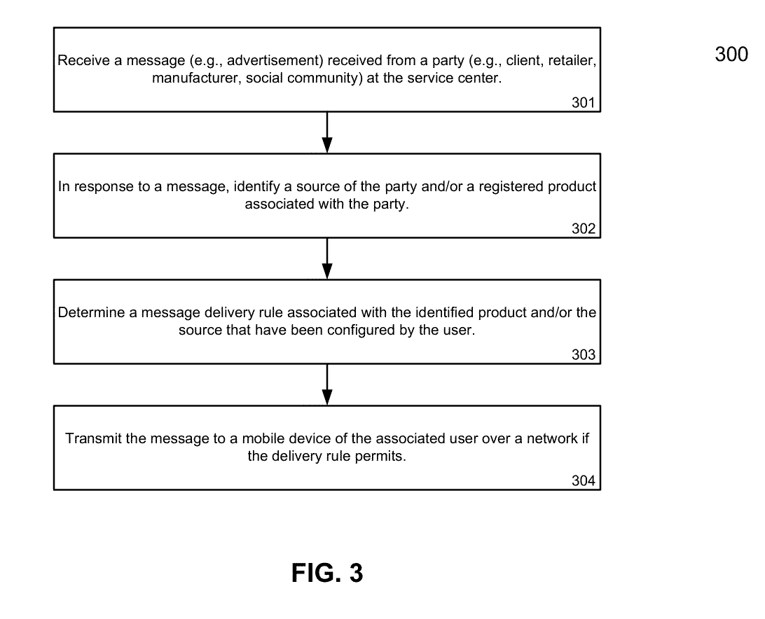

FIG. 3 is a flow diagram illustrating a method for delivering messages by a service center according to one embodiment of the invention. Method 300 may be performed by messaging system 108 of FIG. 2. Referring to FIG. 3, at block 301, a message (e.g., advertisement, feed, or offer) is received at a service center from a party or vendor (e.g., retailer, manufacturer, social community, or other advertisement providers). In response to the message, at block 302, the party or vendor and/or product associated with the source are identified. At block 303, a message delivery rule associated with the identified party and/or product is determined, which has been configured previously by a user. At block 304, the message is transmitted to a mobile device of the user over a network if the delivery rule permits.

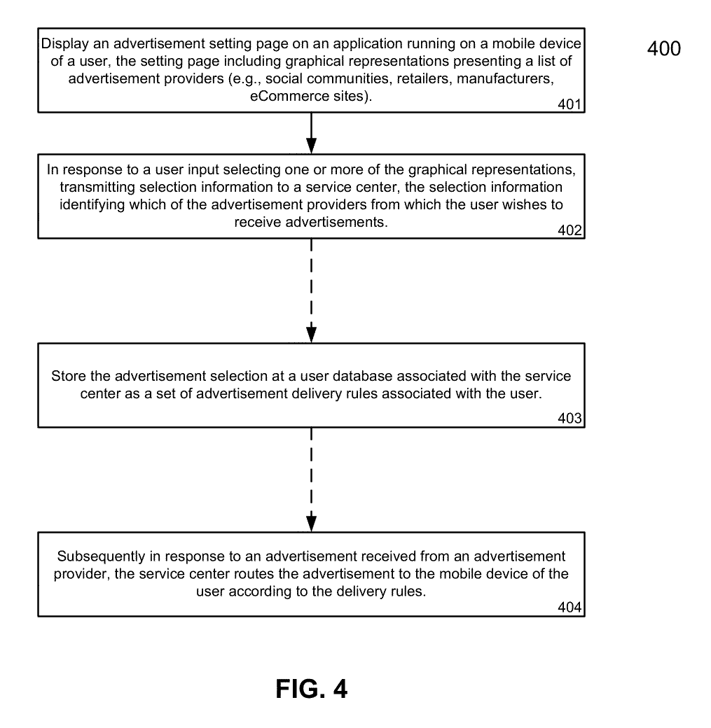

FIG. 4 is a flow diagram illustrating a method for configuring message delivery according to one embodiment of the invention. Method 400 may be performed by mobile device 101 and/or messaging system 108 of FIG. 2. Referring to FIG. 4, at block 401, an advertisement preference setting page is displayed by an application running on a mobile device. The advertisement preference setting page includes graphical representations (e.g., icons) presenting a list of one or more advertisement providers, which can be social communities, retailers, manufacturers, eCommerce facilities, or other advertisement providers. At block 402, in response to a user input selecting one or more of the graphical representations, the selection information is transmitted to a service center. The selection information identifies which of the advertisement providers from which the user wishes to receive advertisements, as described above.

At block 403, the selection information is received at the service center and stored in a database (e.g., user database or user profile) associated with the user of the mobile device as a set of delivery rules for delivering subsequent advertisements. Subsequently at block 404, in response to an advertisement received from an advertisement provider, the set of delivery rules of each user associated with the service center is examined to determine whether the advertisement should be delivered to the corresponding user. If the delivery rules permit, the advertisement is transmitted to a mobile device of the associated user and displayed on a display of the mobile device.

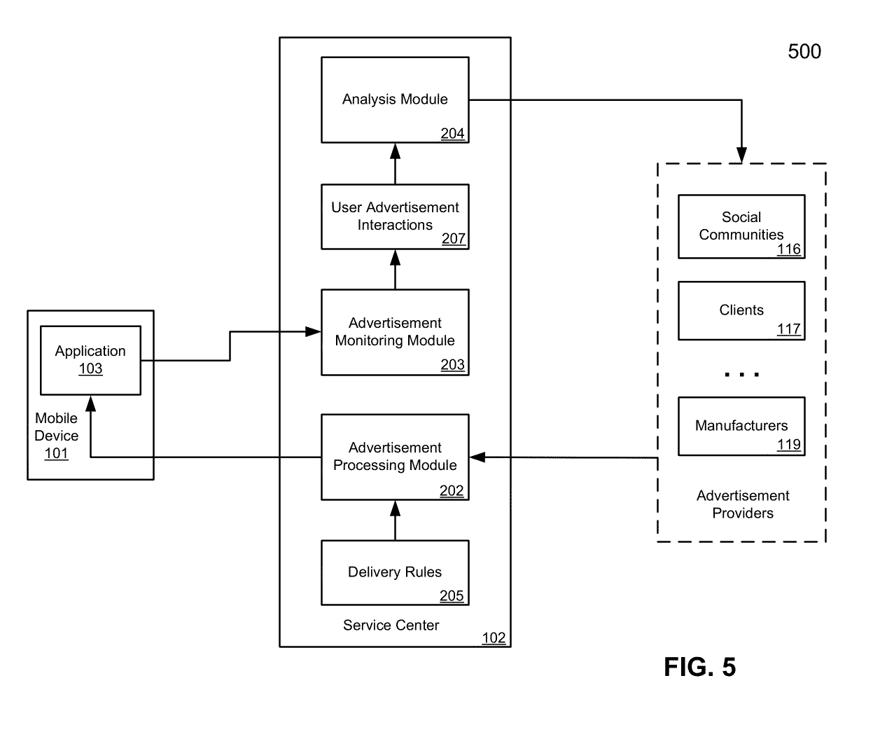

When an advertisement is presented to a user and displayed on a display of a mobile device, according to one embodiment, user interaction with the advertisement currently displayed is monitored and captured for further analysis. FIG. 5 is a block diagram illustrating an advertisement system according to one embodiment of the invention. System 500 may be implemented as part of system 200 of FIG. 2. Referring to FIG. 5, when an advertisement is received at service center 102 from one of advertisement providers such as social communities 116, clients 117, and manufacturers 119, advertisement processing module 202 is configured to deliver the advertisement to application 103 of mobile device 101 based on the associated delivery rules 205, as described above.

The advertisement is then displayed by application 103 on a display of mobile device 101. The advertisement may be displayed in a reduced version such as a rolling band or a thumbnail image within application 103. A user can access the advertisement by activating (e.g., clicking, touching, swiping, or via a key stroke or voice command) the displayed advertisement. When the advertisement is activated, an enlarged version of the advertisement may be displayed. The enlarged version of the advertisement can be displayed within application 103 or alternatively, it can be displayed by another application such as a browser application. The detailed content of the advertisement may be retrieved from a remote server via a link such as a universal resource locator (URL), which may be embedded within the reduced version of the advertisement.

The server that provides content of the advertisement may be maintained by the corresponding advertisement provider. Alternatively, the advertisement may be maintained by service center 102, for example, via a Web interface. In one embodiment, user interaction with the advertisement (e.g., activation of a specific portion or location of the advertisement) is tracked and captured, either by the application presenting the advertisement such as application 103 or a browser application running within mobile device 101. In addition or alternatively, the tracking may be performed by service center 102 or the corresponding advertisement provider, particularly, when the advertisement is presented by service center 102 or the advertisement provider.

If the user interaction is captured by mobile device 101, in this example, application 103, the captured user interaction is transmitted from mobile device 101 and received by monitoring module 203 of service center 102 as part of user interaction information 207. Analysis module 204 is configured to perform an analysis on the user interaction information 207 to derive certain user behaviors or trends with respect to the advertisement. The user interaction with the advertisement may represent certain user interests or attraction of the advertisement. The result of the analysis may be fed back to the advertisement providers for market analysis. As a result, the advertisement providers can further adjust their future advertisements, for example, for better targeted advertisements. Alternatively, the result of the analysis may be utilized by service center 102 to further adjust or modify the associated delivery rules of the user for the purpose of delivering future advertisements.

In addition, according to one embodiment, a client of service center 102 that provides a custom offer to a user or users within service center 102 can receive user data and/or product data (desensitized) collected by service center 102 that will allow the client to derive the marketing data to identify the type of users that has purchased another product over the client's products as a part of a consumer behavior analytics report, to identify number of users having certain products for certain periods of time, thus may be looking to change or upgrade the products, and to identify users that have not elected to purchase or renew service contracts, etc. The client may also create a customer offer to a targeted audience; define the days, times, and terms of the offers that will be presented to the customers; and receive user participation and yield metrics on the activities of the customer offers, etc.

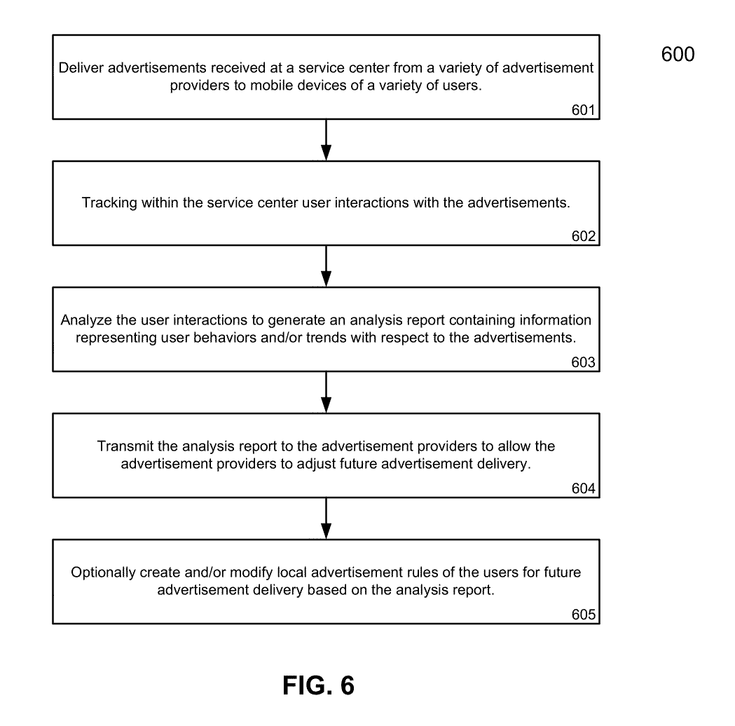

FIG. 6 is a flow diagram illustrating a method of providing advertisements according to another embodiment of the invention. Method 600 may be performed by system 500 of FIG. 5. Referring to FIG. 6, at block 601, in response to advertisements received from a variety of advertisement providers, service center is configured to deliver the advertisements to a variety of users or customers registered with the service center. At block 602, user interactions with the advertisements are tracked by the service center. At block 603, the user interactions are analyzed to generate an analysis report containing information representing user behaviors and/or trends with respect to the advertisements. At block 604, the analysis report is transmitted from the service center to the advertisement providers to allow the advertisement providers to determine future advertisements or offers delivery. At block 605, the local advertisement delivery rules may also be adjusted based on the analysis.

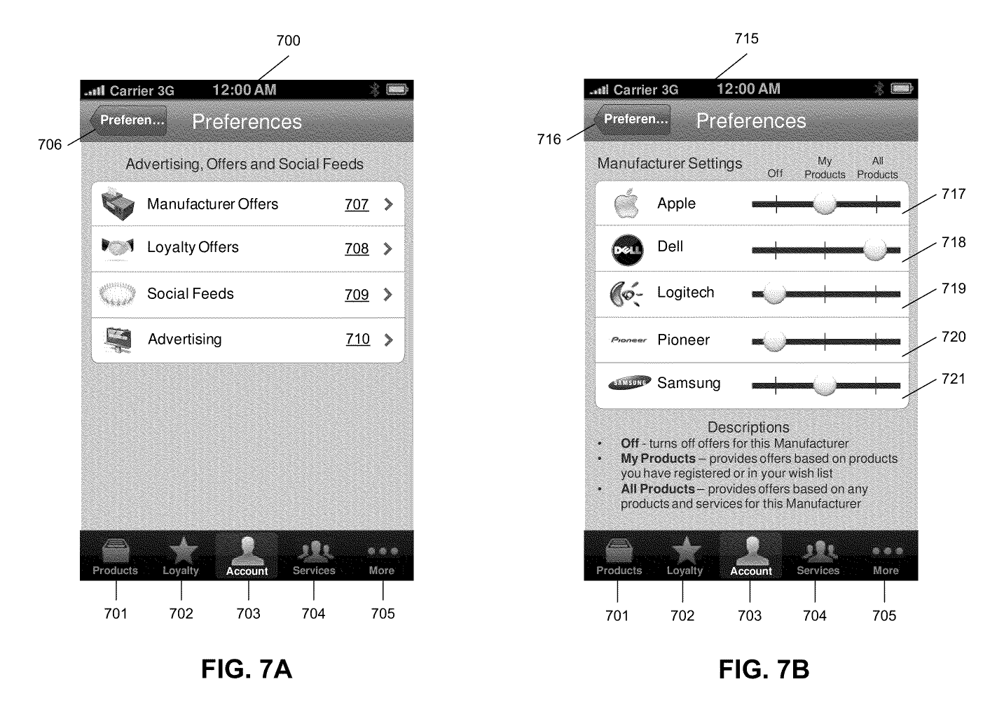

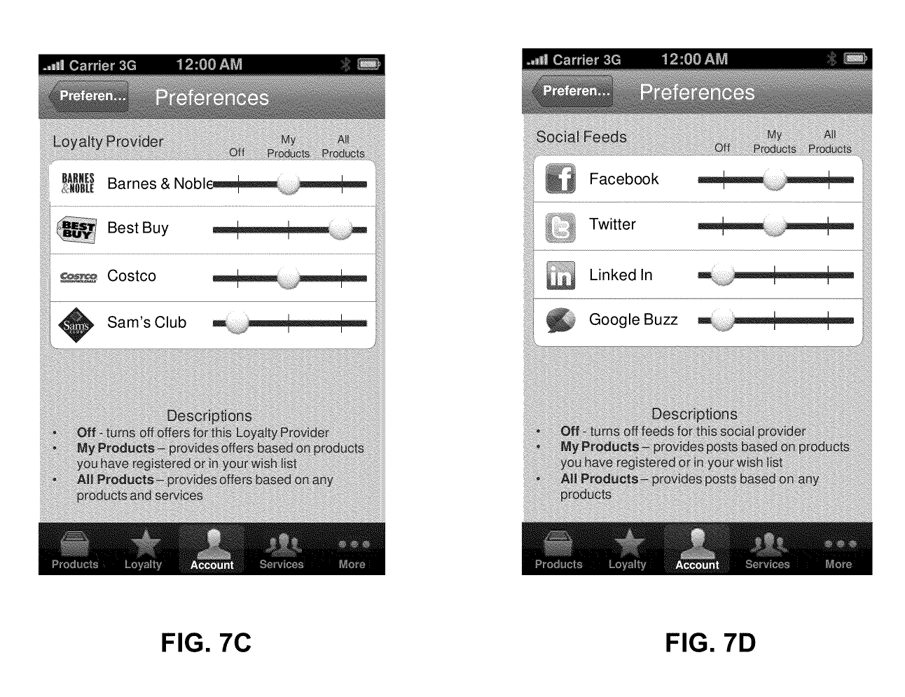

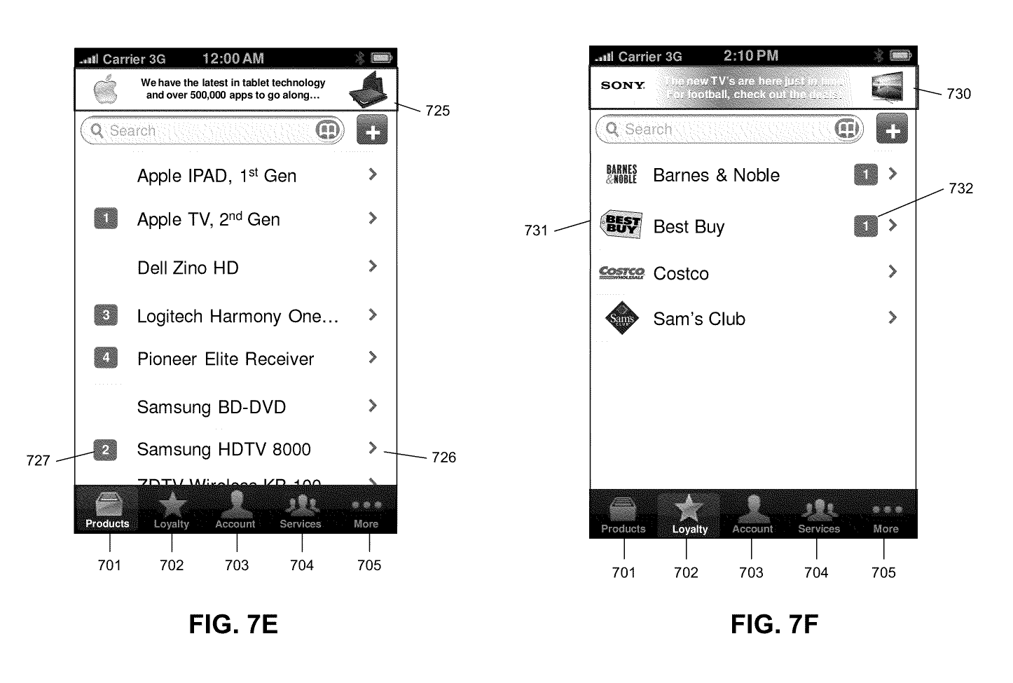

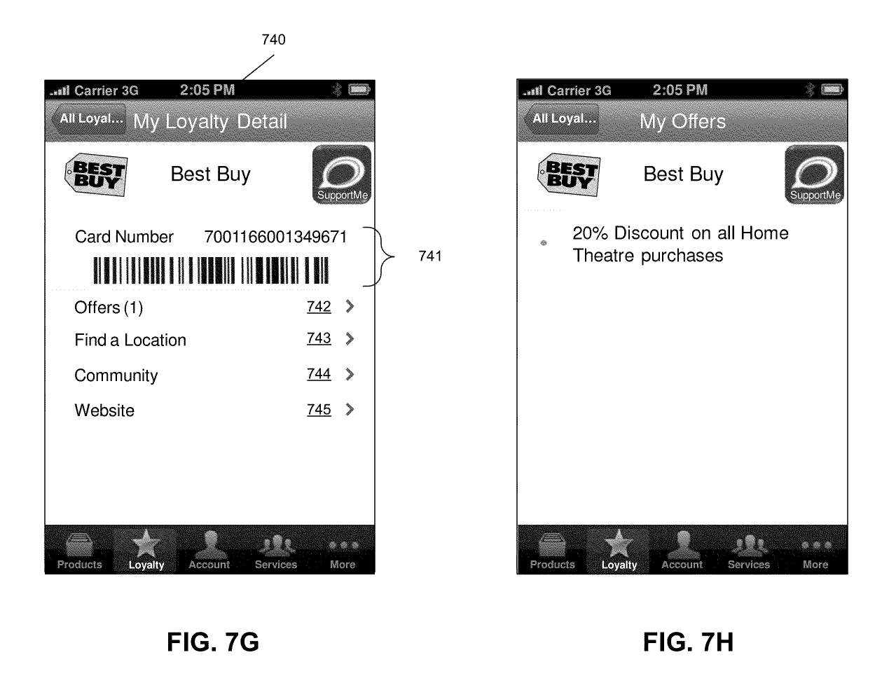

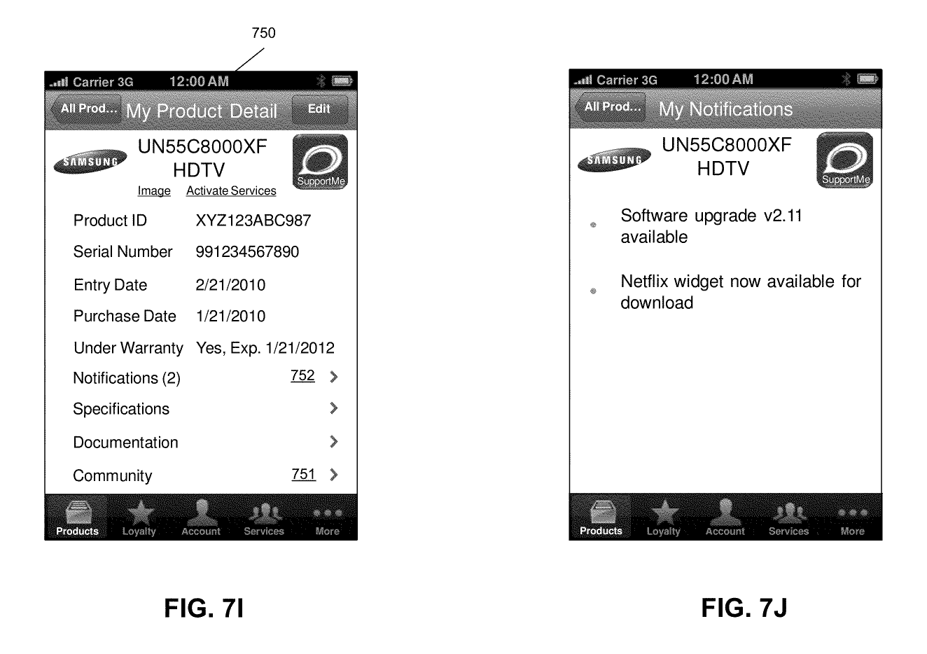

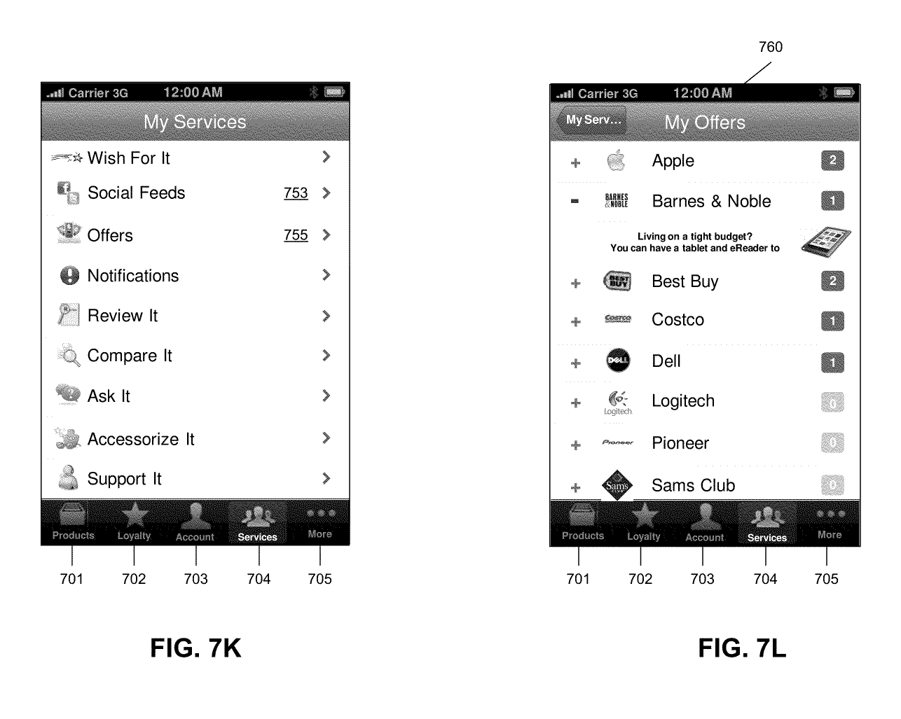

FIGS. 7A-7L are screenshots illustrating examples of graphical user interfaces according to some embodiments of the invention. For example, GUIs as shown in FIGS. 7A-7L may be presented by application 103 of mobile device 101 as described above. Referring to FIG. 7A, GUI 700 includes pages that can be activated and displayed via tabs 701-705, which can be activated by tapping or clicking the corresponding graphical representation, via a key stroke, or via a voice command. In one embodiment, a product page, when activated via tab 701, can be displayed to list one or more products that have been registered with a service center such as service center 102. At least one of the products can be registered by sending a machine-readable code (e.g., barcode, UPC code, or serial number) of the product to the service center without having to provide most of the detailed product information, associated retail information, and/or manufacturer information. The machine-readable code may be obtained or captured using a scanner or camera of the mobile device. In response to the machine-readable code, the service center is configured to communicate with the proper parties or partners to collect and compile all the necessary detailed information associated with the product being registered.

Loyalty page 702 can be used to list one or more loyalty programs that are associated with the user and registered with the service center. A loyalty program can also be registered by scanning a machine-readable code (e.g., barcode of the loyalty card) and sending the machine-readable code to the service center. Account page 703 can be used to configure an account associated with the user, including setting preferences such as communications preference to communicate with the service center and/or agents of a contact center for support services. Services page 704 can be used to obtain a variety of services provided via the service center including, but are not limited to, support services, community services, post market services, and advertisements or messaging service on behalf of a variety of clients. Further detailed information concerning these functionalities can be found in the above incorporated-by-reference patent application.

Referring back to FIG. 7A, GUI 700 can be displayed via a preference setting page of account page 703, where the preference setting page can be displayed from GUI 700 via button 706. The preference page may be used to configure other preferences such as communications channel preferences, etc. In one embodiment, GUI 700 includes a list of various categories of messaging preferences configured to specify whether certain messages of certain categories are to be received by the user. In one embodiment, the categories may include manufacturer offers 707, loyalty offers 708, social feeds 709, and other advertising settings 710. A user can select any one of the categories 707-710 to specifically configure the preferences therein.

Referring now to FIG. 7B, GUI 715 may be activated from link 707 of FIG. 7A and can be used to configure whether a particular offer of a particular manufacturer is to be received by the user. In this example, GUI 715 includes various manufacturers 717-721, each associated with a graphical representation (e.g., icon) representing the corresponding manufacturer. Each of manufacturers 717-721 is associated with a graphical control element to allow a user to configure whether messages or offers from the corresponding manufacturer are to be received by the mobile device. In one embodiment, a user can specify via the associated graphical control element that no message or offer is to be received; only the messages or offers associated with the registered products of the user can be received; messages or offers of all products of the corresponding manufacturer are to be received; or somewhere in between.

In the embodiment as shown in FIG. 7B, a slide bar is utilized as an example of a graphical control element to allow a user to slide the element amongst “Off” (e.g., no message), “My Products” (e.g., only messages for the registered products), and “All Products” (e.g., all messages). However, a graphical control element can be implemented via a variety of GUI components, such as, for example, a scroll bar, a pop-up menu, a pull-down menu, a check box, or a combination thereof, each of these components can be activated via a drag and drop operation using a pointing device (e.g., mouse, stylus, finger), a key stroke, and/or via a voice command. Similarly, preference settings for loyalty offers 708, social feeds 709, and other advertising 710 can also be implemented using techniques similar to those described above, as shown in FIGS. 7C and 7D.

In one embodiment, when a message (e.g., a notification, offer, advertisement) is received at the mobile device from the service center, the message is displayed on a display of the mobile device as shown in FIGS. 7E and 7F. Referring to FIG. 7E, message 725 representing an advertisement is displayed on the product page, which can be activated and displayed via product tab 701. Message 725 may or may not be related to any of the registered products listed in the product page. A user can activate any of the products listed therein to display further detailed information of the corresponding registered product. In addition, in one embodiment, for some of the products, there is an indicator indicating a number of messages, notifications, and/or offers pending associated with the corresponding product. For example, indicator 727 indicates that there are two messages, notifications, and/or offers pending for product 726.

Similarly, on loyalty page as shown in FIG. 7F, message 730 representing an advertisement is displayed, where message 730 may or may not be related to the loyalty providers listed on the page. For some of the loyalty providers (e.g., loyalty provider 731), there is an indicator (e.g., indicator 732) indicating a number of messages, notifications, and/or offers pending associated with the corresponding loyalty program. In one embodiment, a user can display further detailed information of each loyalty program by activating the corresponding link displayed in FIG. 7F. For example, detailed information of loyalty program 731 can be displayed as shown in FIG. 7G by activating the corresponding link.

Referring to FIG. 7G, GUI 740 includes a loyalty program identifier 741 that uniquely identifies the loyalty program. As described above, identifier 741 may be obtained by scanning a machine-readable code (e.g., barcode) of the associated loyalty card using a scanner or camera of the mobile device and sending the code to service center for registration without having to provide detailed information of the loyalty program such as information listed in links 742-745. In response, the service center is able to obtain and compile the information listed in links 742-745. Offers from the corresponding loyalty provider can be displayed via link 742 as shown in FIG. 7H. Similarly, a user can find a retail location associated with the loyalty provider via link 743 (which when activated, a map having one or more indicators indicating a location of a nearby retail location is displayed), a social community associated with the loyalty program via link 744, and a Web site of the loyalty provider via link 745, etc. Note that same or different advertisements may be displayed on different pages (e.g., product page 701, loyalty page 702, account page 703, or service page 704) dependent upon which of the pages is currently displayed. The advertisements may be represented in a round-robin fashion in anywhere of the page (in this example, at the top of the page).

FIG. 7I shows detailed information of a particular registered product. In this example, GUI 750 may be displayed by activating link 726 of FIG. 7E. From GUI 750, a user can find the detailed information, such as product identifier (e.g., machine-readable code), purchase dates, serial number, registration date, related documents and specifications, warranty information a community associated with the product, offers currently offered for the product, etc. Most of this information may be obtained and compiled by the service center in response to a machine-readable code received during the registration. From link 752, a user can access the offers, as shown in FIG. 7J, received from the service center which is delivered based on a set of delivery rules configured by the user as described above. Similarly, a user can find all of the offers from service page 704 as shown in FIG. 7K.

Referring to FIG. 7K, the service page includes various links, each of which can be activated to display further detailed information as described in the above incorporated-by-reference application. For example, a user can activate link 755 to display all of the offers currently received as shown as in FIG. 7L. Referring to FIG. 7L, GUI 760 includes a list of one or more links associated with one or more offer providers. Each of the links, when activated, can be expanded to display one or more offers from the corresponding offer provider. Again, these offers are delivered based on the delivery rules previously configured by the user at the service center. Again note that the GUIs as shown in FIGS. 7A-7L are described for the purpose of illustration only; other formats, layouts, configurations, and/or appearances can also be applied.

According to another embodiment, a service center is configured to identify users that have at least one common product registered with the service center and are also members of a social community. The service center is configured to send a message to those users to invite them to connect (e.g., becoming friends or buddies, or following a friend) with each other via the social community. The social community is hosted by a third party and communicatively coupled to the service center over a network. The service center may also deliver messages or items posted by one of those users to another one of those users on behalf of the social community, without requiring such users to individually or directly access the social community. The service center can also deliver messages or items to a particular user posted by other users of the social community, where the messages or items are related to a registered product of that particular user.

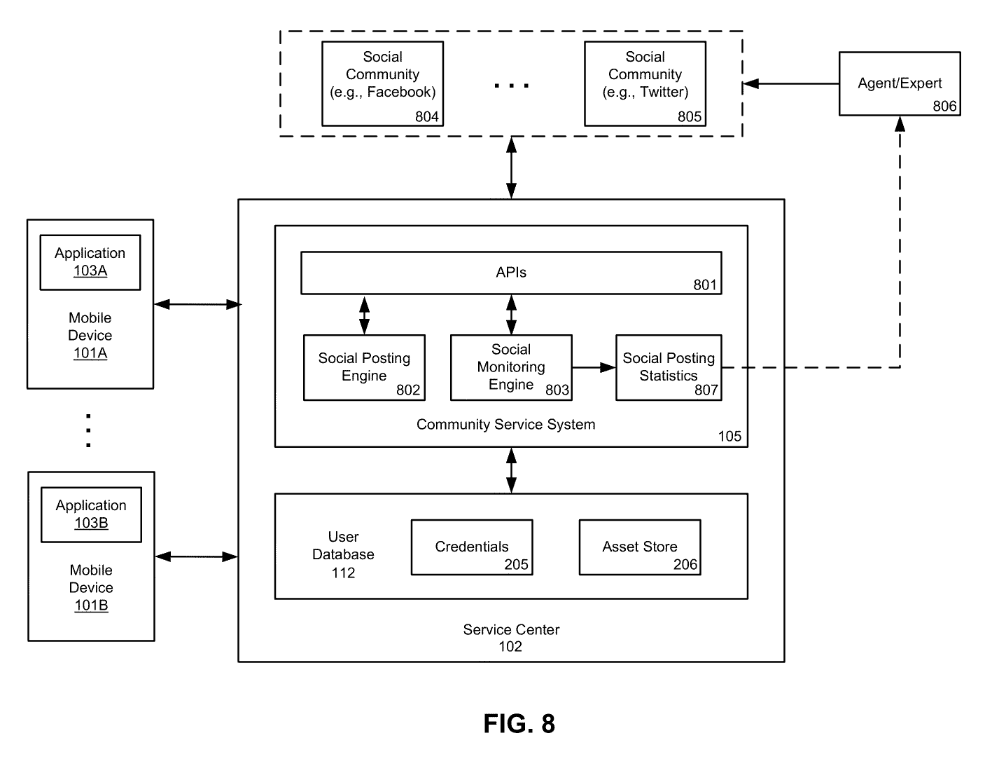

FIG. 8 is a block diagram illustrating a service center having a social community accessing platform according to one embodiment of the invention. Referring to FIG. 8, in one embodiment, community service system 105 includes, but is not limited to, social posting engine 802 and social monitoring engine 803 communicatively coupled to social communities 804-805 via APIs 801. APIs 801 may be implemented as a common API or separate APIs for accessing social communities 804-805, using a variety of communications protocols such as TCP/IP or proprietary protocols. Social posting engine 802 allows a user to post a message via application 103 of mobile device 101 to one or more of social communities 804-805 without having to leave application 103 of mobile device 101.

According to one embodiment, when a user wishes to post a message to one or more of social communities 804-805, the user can create a message on a GUI page of application 103 and specify the social community or communities. The request for posting a message is then transmitted from mobile device 101 to service center 102 and received by social posting engine 802. In one embodiment, the request includes information identifying a message to be posted, one or more social communities in which the message is to be posted, and a registered product associated with the posting. Based on the request, social posting engine 802 is configured to retrieve the necessary credentials from credential store 205 for accessing the social communities. The credentials for accessing social communities 804-805 may be previously registered with service center 102 and stored in credential store 205. Examples of the credentials 205 may include usernames and passwords.

Based on the registered product, social posting engine 802 can also identify one or more discussion threads or forums of social communities 804-805 that are associated with the product. Thereafter, social posting engine 802 transmits via APIs 801 the message and the necessary credentials to one or more of social communities 804-805 for the purpose of posting the message. If a connection to a social community is unavailable at the point in time, social posting engine 802 may store the post in a queue (not shown) until the connection becomes available. As a result, a user does not have to provide the necessary credentials to service center 102 at the time of posting. The user may not have to identify which of the discussion forums or discussion threads in which the message should be posted. All the user needs is to specify which of the social communities and the product associated with the posting.

Similarly, when a response is received from social communities 804-805 in response to the posted message, social posting engine 802 is configured to route the response back to mobile device 101. Alternatively, the response may be routed to the user according to one or more communications channels preferred by the user, which may be configured previously and stored in user database 112 (e.g., user profile). Thus, a single message can be posted onto multiple accounts of the same social community. A single message can also be posted onto multiple accounts across multiple social communities. A social community can be hosted or maintained by a third-party social networking provider (e.g., Facebook®, Twitter®), a retailer (e.g., Amazon®, Bestbuy®), or a manufacturer (e.g., Samsung®).

According to one embodiment, community service system 105 further includes social monitoring engine 803 configured to monitor message postings to social communities 804-805 via social posting engine 802 and the responses received from social communities 804-805. In one embodiment social monitoring engine 803 is configured to collect data concerning all the social posting activities. The data collection may include, but is not limited to, user IDs and date and time of post, communities the pose is made to, user accounts post is being made to, user account the post is being made from, device the post is being made from (e.g., mobile, tablet, Web), etc. Based on the monitoring, social posting statistics 807 can be generated. In one embodiment, social posting statistics 807 includes, but is not limited to, a number of posts by time and day, number of posts by day of week, number of users creating posts, number of products with posts, number of brands or loyalty with posts, and products least posted about, etc.

In one embodiment, an enhanced analysis may be performed on the collected data and statistics to identify trends, activities based on events, including, but not limited to, most social channels used to post, the types of accounts (e.g., user accounts, manufacturers/loyalty accounts or both) of the posts, products associated with the posts, services associated with the posts, the brands associated with the posts, number of the posts by products and services, and times of day and days of week of the posts, etc.

Social monitoring engine 803 is configured to monitor a social environment gathering data about topics posted in communities 804-805. In one embodiment, social monitoring engine 803 is configured to identify posts that have both positive and/or negative sentiments regarding a product or brand. Social monitoring engine 803 may also identify activities based on either the positive or negative sentiment such as whether the traffic is heavy on the topic, whether a positive sentiment is trending negative, and whether a negative sentiment is trending positive. Social monitoring engine 803 may also determine other social community sites that are discussing the same or similar topics or trends. Social monitoring engine 803 may also determine the most active users participating in the community and/or whether the community is working to find a solution or the community needs an assistance to move forward. The sentiment data or social statistics 807 can be utilized by agent/expert/specialist 806 to participate in the discussion, for example, by interjecting comments into a negative discussion and attempting to turn it positive, or identifying a solution that the community has found to be positive and posts to other communities that may not have knowledge of the resolution. The solution or comments posted in a discussion forum may also be converted into knowledgebase (e.g., KB 113 of FIG. 1) for future references.

In one embodiment, based on the monitoring, a user having participated in a discussion and posted positive comments about a product may be rewarded by the service center, a retailer, and/or a manufacturer associated with the product. A user having posted a negative comment about a product may be contacted by an agent, expert, or specialist to resolve the issues in an attempt to turn the negative experience into a positive one. Further detailed information concerning community service system 105 can be found in co-pending U.S. patent application Ser. No. 13/185,213, entitled “Platform for Providing Life-Cycle Product Support Services,” filed Jul. 18, 2011, which is incorporated by reference herein in its entirety.

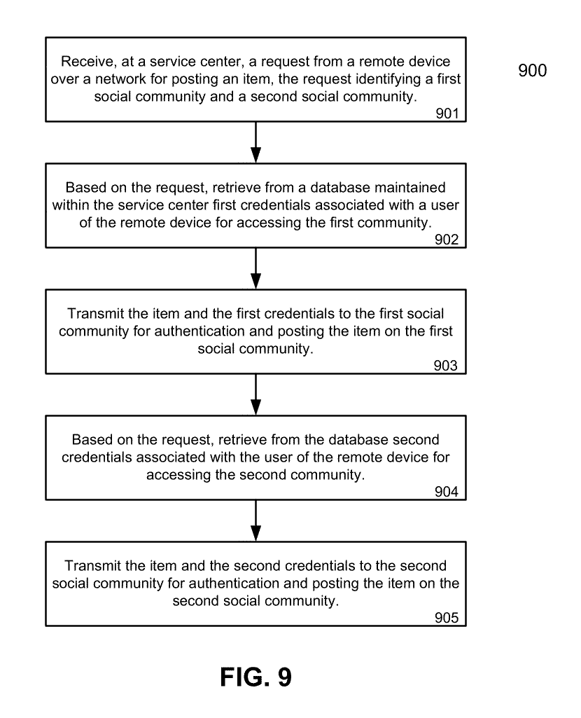

FIG. 9 is a flow diagram illustrating a method for social posting via a service center according to one embodiment of the invention. Method 900 may be performed by community service system 105 of FIG. 8. Referring to FIG. 9, at block 901, a service center receives a request from a mobile device over a network for posting an item. The request identifies a first social community and a second social community. At block 902, based on the request, first credentials associated with the user for accessing the first social community is retrieved from a database. At block 903, the item and the first credentials are transmitted to the first social community for authentication of the user and posting the item on the first social community. At block 904, based on the request, second credentials associated with the user for accessing the second social community are retrieved from the database. At block 905, the item and the second credentials are transmitted to the second social community for authentication of the user and posting the item on the second social community. As a result, the user does not have to provide the credentials at the point in time of the posting.

According to another embodiment of the invention, referring back to FIG. 8, social posting engine 802 can also identify users that have at least one common product registered with service center 102 and those users are also a member of one or more social communities such as social communities 804-805. These users can be identified based on their registered products (e.g., asset store 206) and/or social community settings (e.g., social community credentials 205) that have been configured during the registration. Alternatively, these users may be identified based on their interaction or behaviors with the service center (e.g., interaction with advertisements, wish list, social posts, buy/sell transactions, etc.).

In one embodiment, based on users' social community settings, social posting engine 802 or another component can identify those users are members of the same social community. Based on the product asset stores of the users, social posting engine 802 can identify the users who have at least one common registered product. Based on the user interactions or behaviors with the service center (e.g., tracked by social monitoring engine 803 of FIG. 8 and/or monitoring module 203 of FIG. 2) over a period of time, service center 102 is able to identify certain users who may have at least one common interest, wish to share their experience of a product or service, wish to share best practices for the use of a product or service, wish to share custom setup or configurations of a product or service registered via the support center.

For example, based on a variety of information available to service center 102 as described above, social posting engine can identify users associated with mobile devices 101A and 101B have at least one common registered product and they are members of at least one common social community. Social posting engine 802 can send a message to a user of mobile device 101A to invite the user to connect with a user of mobile device 101B, or vice versa. Social posting engine 802 can send a message including information identifying at least one common product registered by both users. Social posting engine 802 can also send a message including an item recently posted by the other concerning at least one common product or service. Social posting engine 802 can also send a message including an item posted by another member of the same social community concerning a registered product or a product that may be interesting or related to a user based on the user's past interaction or behaviors. Reposting information of a user is available so information received from a user being followed can be shared further with user following the user who is attempting to repost a users post.

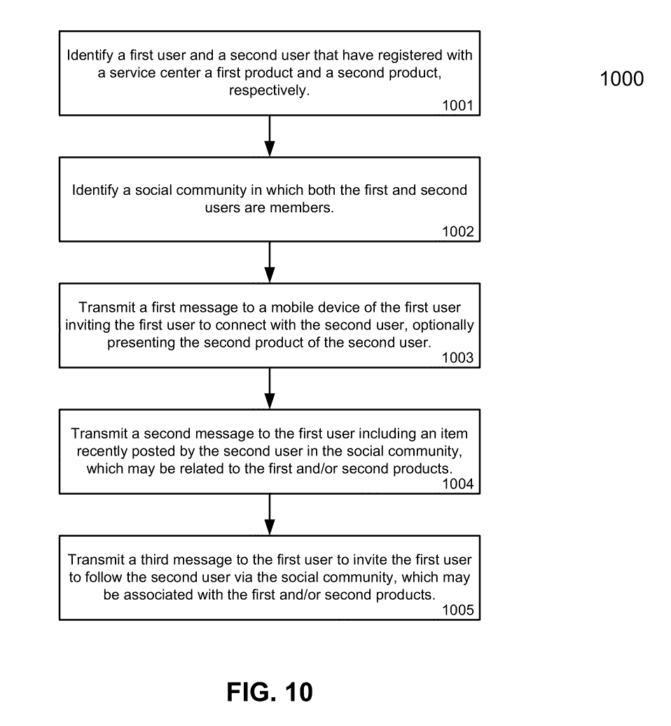

FIG. 10 is a flow diagram illustrating a method for providing social community services according to one embodiment of the invention. Method 1000 may be performed by system 800 of FIG. 8. Referring to FIG. 10, at block 1001, a first user and a second user that have registered a first product and a second product, respectively, with the service center are identified. The first and second users can be identified based on their product asset stores. At block 1002, a social community is identified of which both the first and second users are members. At block 1003, a first message is transmitted to a mobile device of the first user to invite the first user to connect with the second user. The first message may include information identifying a second product of the second user. At block 1004, a second message is transmitted from the service center to the mobile device of the first user, where the second message includes or identifies an item recently posted by the second user in the social community. The item may or may not be related to the first and/or second products. At block 1005, a third message is transmitted to the first user to follow the second user via the social community, which may be associated with the first and/or second products.

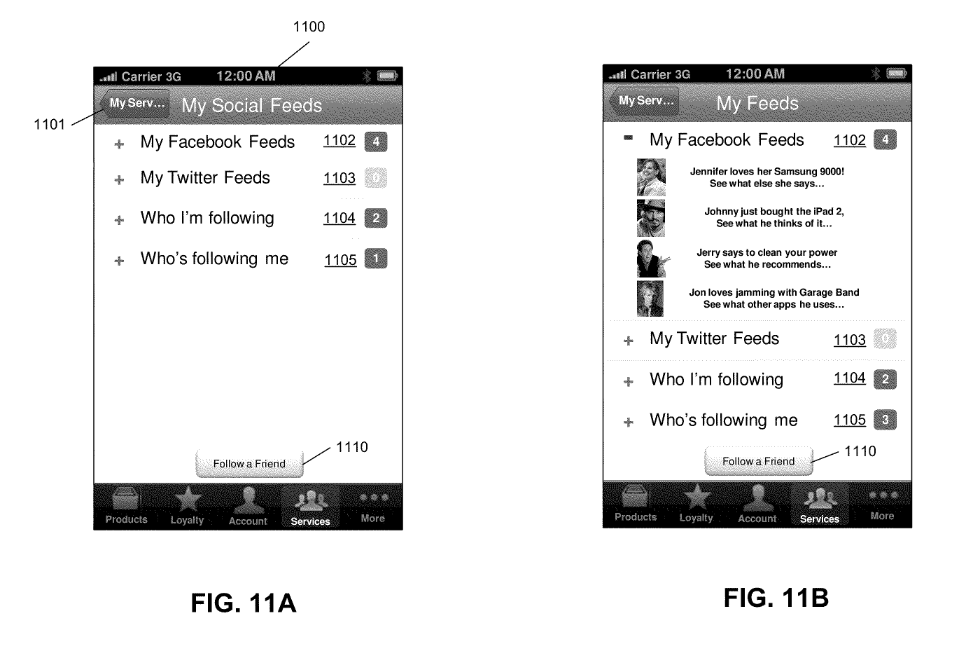

FIGS. 11A-11B are screenshots illustrating an example of a graphical user interface according to one embodiment of the invention. FIGS. 11A-11B may be presented by application 103A or 103B of FIG. 8. Referring to FIG. 11A, GUI page 1100 includes all the social feeds that a user can receive from various social communities. GUI page 1100 may be displayed by activating link 753 of a service page as shown in FIG. 7K, where the service page can be redisplayed via button 1101. In this example, social feeds include feeds 1102 from a first social community and feeds 1103 from a second social community that are associated with the user. The information of these social communities such as credentials have been registered and configured by the user. Via one or more social communities, a user is able to follow other members of the social communities. A user can view the posts of other users that the user is following via link 1104 or find out who is following the user via link 1105. A user can also follow additional users registered with the service center via button 1110. In one embodiment, if a user wishes to follow someone they know is registered with the service center, they can activate button 1110 to search for a friend (not shown) and add them to their “Who I′m Following” list. However, at this point in time, they may not be able to see any posts from their friend until the person they requested to follow approves the request. If the person receiving the request does not know or wishes to not allow the requester to follow them they may decline the request. The user receives notification of either the acceptance or the decline of their request. Once they are accepted they will be able to open and view the posts just as they do with 1102. Clicking on the post takes them to a page that shows the full detail of the post. Each of links 1102-1105 can be activated to display further detailed information. For example, when link 1102 is activated, the link is expanded to display more detailed information as shown in FIG. 11B.

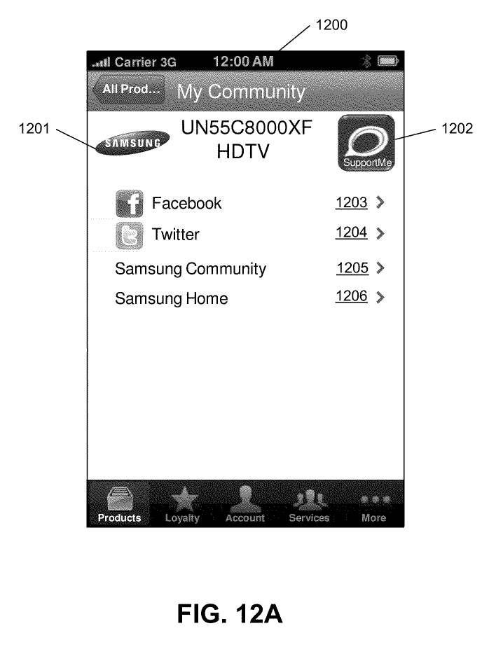

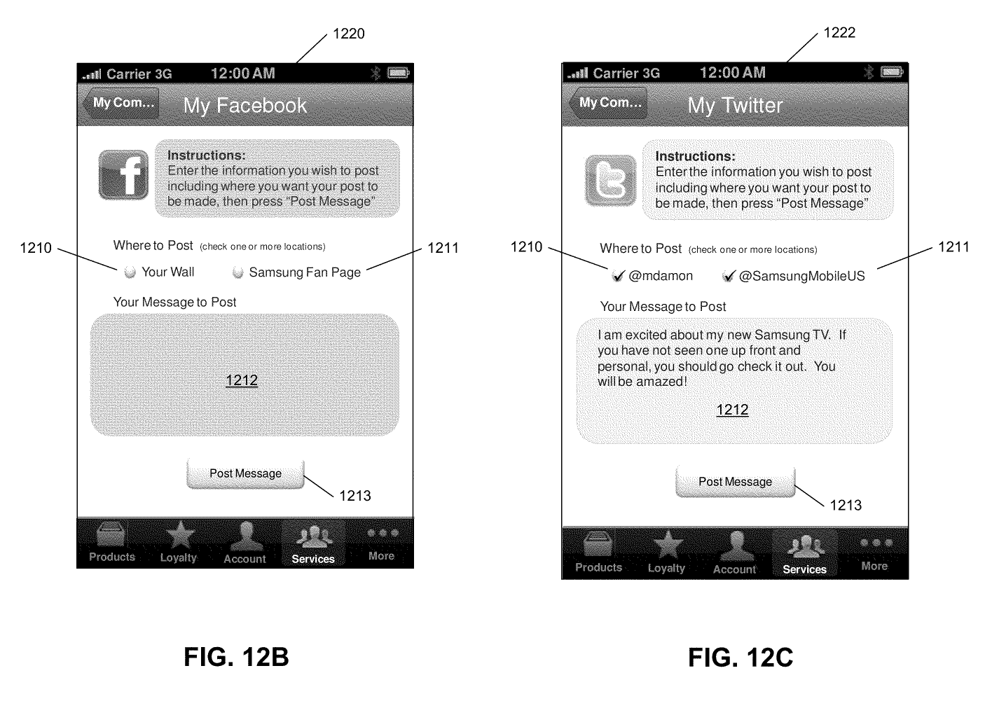

FIGS. 12A-12C are screenshots illustrating graphical user interfaces for posting items on social communities according to one embodiment of the invention. GUI 1200 may be activated from link 751 of FIG. 71. Referring to FIG. 12A, GUI 1200 displays a title or abstract 1201 of a particular product and a support button 1202. A user can activate support button 1202 to contact an agent or expert for support services as described in the above incorporated-by-reference application.

In addition, GUI 1200 includes a list of social communities 1203-1206 that the user has previously registered with the service center, including providing the necessary credentials for accessing social communities 1203-1206, as described above with respect to FIGS. 4A-4D. The credentials are stored within the service center, for example, as part of a user database or user profile associated with the user. A user can select or activate any of the social community links 1203-1206 to post a message to the selected social community or communities.

For example, if a user selects link 1203, a posting page associated with selected social community is displayed as shown in FIG. 12B. Referring to FIG. 12B, GUI 1220 includes one or more graphical representations 1210-1211 representing different accounts associated with social community 1203 for the selected product 1201. A graphical representation can be an icon, a button, or a checkbox, etc. GUI 1220 also includes an input field 1212 to allow a user to enter a message to be posted to one or more of accounts 1210-1211, which may be selected by activating or selecting the corresponding graphical representations. Once the message has been entered in input field, the user can activate button 1213 to post the message to the selected social communities.

In response to the activation of button 1213, the underlying application is configured to transmit the message, the associated product identifier, and identifier(s) identifying one or more social communities to the service center. The service center can then compile the necessary detailed product information to determine one or more discussion threads or forums, as well as the necessary credentials for accessing the selected social communities. Thereafter, the service center posts the message to the identified discussion threads of selected social communities on behalf of the user using associated credentials. As a result, the user does not have to identify the discussion threads or provide the necessary credentials for accessing the selected social communities. Similarly, a user can post a message in community 1204 via GUI 1222 as shown in FIG. 12C.

Note that a single message can be posted, via a single transaction from a mobile device, on different social communities, different accounts of the same social community, or different accounts on different social communities. Also note that the GUIs as shown in FIGS. 12A-12C are described for illustration purpose only; other layouts or formats may also be applied. Any of the selectable graphical representations described herein can be activated via a keystroke on a keyboard, a mouse click, tapping or swiping on a touch screen, and/or a voice command, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for providing support services to users of products, the method comprising:
identifying, at a service center, a first and a second of a plurality of users supported by the service center for a plurality of products registered with the service center, the service center configured to provide support services to the users concerning the products on behalf of vendors that provide the products, wherein the first user and the second user have at least one common product registered with the service center;
determining, at the service center, whether the first user and the second user are members of a social community that is communicatively coupled to the service center via a first application programming interface (API), wherein the social community is hosted by a third party over a network; and
transmitting, via a second API over the network, a first message to a first mobile device associated with the first user to enable the first user to connect with the second user via the social community without requiring the first user directly accessing the social community.

2. The method of claim 1, wherein the first message includes information identifying the at least one common product associated with the first user and the second user that has been registered with the service center.

3. The method of claim 1, further comprising:
receiving a request in response to the first message from the first mobile device via the second API, the request requesting connecting with the second user via the social community;
retrieving from a database of the service center credentials associated with the first user for accessing the social community, without prompting the first user for the same credentials; and
transmitting on behalf of the first user via the first API, the request and the credentials to the social community over the network to allow the social community to authenticate the first user based on the credentials and to connect the first user with the second user based on the request.

4. The method of claim 1, further comprising:
receiving a second message from the social community via the first API, the second message including an item posted in the social community by a third user commenting on the at least one common product;
accessing a first set of one or more delivery rules associated with the first user stored in the database to determine whether the item should be delivered to the first user; and
transmitting the item to the first mobile device of the first user to be displayed on a display of the first mobile device if the first set of delivery rules permits.

5. The method of claim 4, further comprising:
accessing a second set of one or more delivery rules associated with the second user to determine whether the item should be delivered to the second user; and
transmitting the item to a second mobile device of the second user to be displayed on a display of the second mobile device if the second set of delivery rules allows.

6. The method of claim 4, wherein the first set of one or more delivery rules has been previously configured by the first user regarding whether certain types of messages should be delivered to the first mobile device of the first user.

7. The method of claim 4, further comprising:
receiving, at the service center, a third message from a vendor that provides the at least one common product, the third message including an advertisement of at least one of an upgrade of the at least one common product, a promotion of a related product, and a reward or discount for other products provided by the vendor; and
transmitting the advertisement to the first mobile device to be displayed on the display of the first mobile device if the first set of one or more rules allows.

8. The method of claim 7, further comprising:
monitoring interaction of the first user with the advertisement displayed on the first mobile device;
performing an analysis on the interaction to determine behaviors or trends of the first user with respect to the advertisement; and
transmitting a result of the analysis to the vendor to allow the vendor determining subsequent advertisements.

9. The method of claim 8, further comprising transmitting a suggestion of another product to the first mobile device of the first user based on the analysis.

10. The method of claim 1, wherein the at least one common product was registered by transmitting a machine readable code uniquely identifying the at least one common product from the first mobile device to the service center, wherein the machine-readable code was obtained by scanning the at least one common product using a scanner of the first mobile device, and wherein the service center is configured to compile the detailed information of the at least one common product without specifically providing detailed information of the at least one common product.

11. A machine-readable storage medium having instructions stored therein, which when executed by a processor, cause the processor to perform a method for providing support services to users of products, the method comprising:
identifying, at a service center, a first and a second of a plurality of users supported by the service center for a plurality of products registered with the service center, the service center configured to provide support services to the users concerning the products on behalf of vendors that provide the products, wherein the first user and the second user have at least one common product registered with the service center;
determining, at the service center, whether the first user and the second user are members of a social community that is communicatively coupled to the service center via a first application programming interface (API), wherein the social community is hosted by a third party over a network; and
transmitting, via a second API over the network, a first message to a first mobile device associated with the first user to enable the first user to connect with the second user via the social community without requiring the first user directly accessing the social community.

12. The machine-readable storage medium of claim 11, wherein the first message includes information identifying the at least one common product associated with the first user and the second user that has been registered with the service center.

13. The machine-readable storage medium of claim 11, wherein the method further comprises:
receiving a request in response to the first message from the first mobile device via the second API, the request requesting connecting with the second user via the social community;
retrieving from a database of the service center credentials associated with the first user for accessing the social community, without prompting the first user for the same credentials; and
transmitting, on behalf of the first user via the first API, the request and the credentials to the social community over the network to allow the social community to authenticate the first user based on the credentials and to connect the first user with the second user based on the request.

14. The machine-readable storage medium of claim 11, wherein the method further comprises:
receiving a second message from the social community via the first API, the second message including an item posted in the social community by a third user commenting on the at least one common product;
accessing a first set of one or more delivery rules associated with the first user stored in the database to determine whether the item should be delivered to the first user; and
transmitting the item to the first mobile device of the first user to be displayed on a display of the first mobile device if the first set of delivery rules permits.

15. A method performed by a mobile device, comprising:
displaying a first graphical user interface (GUI) page on a display of a mobile device, the first GUI page including one or more first graphical representations, each representing a social community, wherein each of the first graphical representations is associated with an input field to allow a user of the mobile device to specify whether a message originated from the corresponding social community should be received by the mobile device; and
in response to a first user input from the first GUI page, transmitting settings accepted via input fields of the first graphical representations to a service center over a network to be stored in a database of the service center, wherein the service center is configured to provide support services to a plurality of products registered by a plurality of users, and wherein the service center is configured to route messages received from one or more social communities represented by the first graphical representations to the mobile device based on the settings stored in the database without requiring the user of the mobile device to directly and individually access the one or more social communities.

16. The method of claim 15, wherein the messages received from the one or more social communities are originated from one or more discussion forums of the one or more social communities associated with one or more products registered by the user of the mobile device.

17. The method of claim 15, further comprising:
displaying a second GUI page on the display of the mobile device, the second GUI page including one or more second graphical representations, each representing a vendor that provides a registered product associated with the user, wherein each of the second graphical representations is associated with an input field to allow the user to specify whether an advertisement originated from the corresponding vendor should be received by the mobile device; and
in response to a second user input from the second GUI page, transmitting settings accepted via input fields of the second graphical representations to the service center to be stored in the database of the service center, wherein the service center is configured to route advertisements received from one or more vendors represented by the second graphical representations to the mobile device based on the settings stored in the database.

18. The method of claim 17, further comprising:
in response to an advertisement received from the service center, displaying the advertisement on the display of the mobile device, wherein the advertisement was originated from a vendor and received by the service center;
capturing user interaction of the user of the mobile device with respect to the displayed advertisement; and
transmitting the user interaction to the service center over the network, wherein the user interaction with the advertisement is used by the service center to determine delivery of subsequent advertisements.

19. The method of claim 17, wherein the input field of each of second graphical representations is used to allow a user to specify whether an advertisement associated with one of a product registered with the service center by the user and a product associated with the corresponding vendor should be delivered to the mobile device.

20. A computer-implemented method, comprising:
receiving, at the service center, a message from a vendor that provides a product registered with the service center, the message including an advertisement of at least one of an upgrade of the registered product, a promotion of a related product, and a reward or discount for other products provided by the vendor, wherein the service center is configured to provide support services to users of a plurality of products registered with the service center on behalf of a plurality of vendors that provide the products;
in response to the advertisement, retrieving a set of one or more delivery rules associated with a user to determine whether the advertisement should be delivered to the user, wherein the set of one or more delivery rules have been previously configured and stored in a database of the service center; and
transmitting the advertisement to a mobile device associated with the user to be displayed on the display of the mobile device if the set of one or more delivery rules allows.

21. The method of claim 20, further comprising:
monitoring interaction of the user with the advertisement displayed on the mobile device;
performing an analysis on the interaction to determine behaviors or trends of the user with respect to the advertisement; and
transmitting a result of the analysis to the vendor to allow the vendor determining delivery of subsequent advertisements.

22. The method of claim 21, further comprising transmitting a suggestion of another product to the first mobile device of the first user based on the analysis.
